(19) United States
(12) Patent Application Publication
(10) Pub. No.: US 2007/0285932 A1
(43) Pub. Date: Dec. 13, 2007

(54) BASE FOR A LAMP

(75) Inventors: Stephan Berndanner, Yokohama (JP); Richard Lang, Kinding (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/759,567

(22) Filed: Jun. 7, 2007

(30) Foreign Application Priority Data
Jun. 7, 2006 (DE) 10 2006 026 485.1

(51) Int. Cl. F21V 19/00

(52) U.S. Cl. 362/382

(57) ABSTRACT

A base for a discharge lamp has a stainless steel material which discolors in the visible region above a predetermined temperature, it being possible to perceive such a discoloration preferably above approximately 230° C. with an increasingly strong yellow tarnishing color.

### TECHNICAL FIELD

The invention relates to a base for a lamp, preferably a discharge lamp.

### PRIOR ART

The term “discharge lamp” in this case includes sources of electromagnetic radiation based on gas discharges. The spectrum of the radiation can in this case include both the visible region, and the ultraviolet region and the vacuum ultraviolet region as well as the infrared region. In addition, a fluorescent coating may also be provided for converting invisible radiation into visible radiation (light).

The patent U.S. Pat. No. 4,559,472 has disclosed a high-pressure discharge lamp having 3 base sleeve 3 shown in FIGS. 1 and 2 which has been fitted onto a discharge vessel 2. The base sleeve fulfills a dual function: it performs the function of supplying power and is used for fixing the lamp in the luminaire.

Owing to the rotationally symmetrical design of the special discharge lamps with their axial power supply lines, which is also described in the abovementioned patent application, a base may be provided at two ends. Brass sleeves, which have been nickel-plated and chromium-plated in order to protect them against oxidation, are used as the base sleeves. In the prior art, nickel-plated and chromium-plated steel bases are also used.

Until now, the nickel-plated steel bases have also been used as a temperature indicator for thermal overloading, whereby a first slight tarnishing color became visible at a temperature of 380° C.

### DESCRIPTION OF THE INVENTION

The invention is based on the object of providing a base for a discharge lamp, in which thermal overloading can be identified early.

This object is achieved according to the invention in that at least sections of the base have a stainless steel material which discolors in the visible spectral region above a predetermined temperature.

The invention discloses a base for a discharge lamp which is characterized by the fact that at least sections of it have a stainless steel material which discolors in the visible region above predetermined temperatures. The base consisting of stainless steel material can therefore be used as a temperature indicator, from which it is possible to read possible cooling problems of the discharge lamp even in the event of a small degree of thermal overloading owing to the discoloration.

The stainless steel material preferably begins to discolor in the visible region at a temperature of between 230° C. and 280° C., with the result that, in comparison with the nickel-plated steel base, in which a slight tarnishing color can only be perceived above a temperature of 380° C., in the present invention it is possible to perceive thermal overloading even at a temperature which is lower by at least 100° C.

Preferably, the stainless steel material is selected in such a way that a discoloration in the visible region begins at a temperature of above approximately 280° C., Consequently, thermal overloading is visible even in the event of the maximum permissible base temperature being exceeded only slightly.

The base is preferably formed in such a way that, when the discharge lamp has been introduced into the base, the section consisting of stainless steel material is provided adjacent to the discharge vessel of the discharge lamp, preferably such that it is in touching contact with it. As a result, the temperature difference between the stainless steel base and the discharge vessel is small, and the stainless steel material can function with a high degree of accuracy as a temperature indicator for the temperature of the discharge vessel.

It is particularly advantageous if the fastening ring of the base, which until now has been produced from nickel-plated or chromium-plated brass, is now likewise produced from stainless steel material, in order to make available a large area for the temperature indication on the base.

Particularly advantageous embodiments of the invention are described in the dependent claims.

### BRIEF DESCRIPTION OF THE DRAWINGS

The invention will be explained in more detail below with reference to a preferred exemplary embodiment. In the drawings:

FIGS. 1 end 2 show a section of a high-pressure discharge lamp having a base, in a plan view and in section, and

FIGS. 3 to 7 show temperature profiles over time in a series of tests for testing the tarnishing behavior at temperatures of 200° C. 230° C., 280° C., 330° C. and 440° C.

### PREFERRED EMBODIMENT OF THE INVENTION

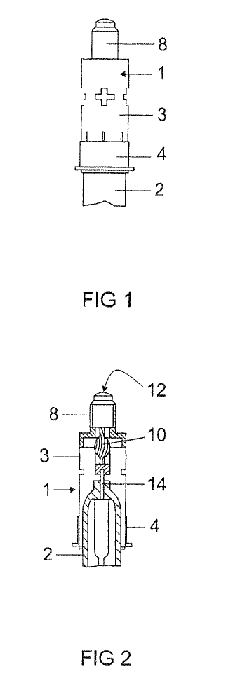

It can be seen from the sections of the high-pressure discharge lamp from the prior art which are shown in FIGS. 1 and 2 that a base sleeve 3 has been fitted to a discharge vessel 2, which base sleeve 3 is fastened to the discharge vessel 2 via a fastening ring 4, which forms the base 1 together with the base sleeve 3.

According to the present invention, the base sleeve 3 is produced from a stainless steel material and has a sleeve section 6, which surrounds sections of the discharge vessel 2, and a hollow cylinder section 8 having a smaller diameter than the sleeve section 6. The power supply line, which is in the form of a braided wire, is introduced into the hollow cylinder section 8 and electrically connected to the end face 12 of the hollow cylinder section 8. The supply of electrical power to the discharge vessel 2 takes place from the end face 12 via the power supply line 10, which is connected to an electrode holding rod 14.

Owing to the fact that the base sleeve 3 is fastened to the discharge vessel 2 via the fastening ring 4 or alternatively without the use of a fastening ring, heat transfer takes place between the discharge vessel 2 and the base sleeve 3. The prescribed maximum temperature without overloading is generally 230° C. in the case of discharge lamps. The nickel-plated steel base from the prior art demonstrated first slight tarnishing colors at a temperature of 380° C. and clearly visible very yellow tarnishing colors only at a temperature of 4400C.

Owing to the use according to the invention of a stainless steel material, slow discoloration, i.e. a transition to a specific tarnishing color above the prescribed maximum permissible base temperature of 230° C. is ensured, the stainless steel material discoloring very slowly from yellow to blue above approximately 230° C.

Owing to such a use of the stainless steel material as a temperature indicator, it is possible to recognize early, without damaging the lamp, that cooling problems are occurring and therefore the lamp could be subject to damage or failure if operation were to continue. The base sleeve is preferably arranged such that the tarnishing region is visible.

Optimization of the cooling guidance or adjustment of the cooling air flow can take place as countermeasures and, if no thermal overloading has become visible yet on the other component parts, such as glass fuses, electrodes or the glass bulb, for example, the lamp is provided with a new base and operation is continued.

In order to prove the tarnishing behavior of the stainless steel material according to the invention in comparison with a nickel-plated steel base, a series of tests were carried out. In the process, in each case one nickel-plated steel base and one stainless steel base were subjected to different temperatures in a furnace over 24 hours. The bases were subjected to a plurality of thermal cycles, the maximum temperature being significant for the function as a temperature indicator.

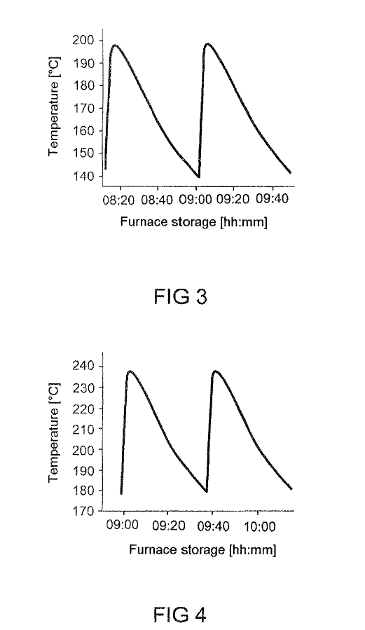

FIGS. 3 to 7 illustrate the temperature profile over time of the furnace storage, clearly showing the thermal cycles, which were the same for the nickel-plated steel base and the stainless steel base. These figures show, apart from the respective cycle duration, the rate at which heating to the maximum temperature and cooling both of the nickel-plated steel base and of the stainless steel base take place.

FIG. 3 shows the temperature profile at 200° C., in which a cycle had a duration of 50 minutes and the respective base was subjected to 29 cycles. The 200° C. is below the maximum permissible base temperature of 230° C., and a tarnishing color could not be perceived either on the nickel-plated steel base or on the stainless steel base.

FIG. 4 shows the temperature profile at 230° C., in which the thermal cycle had a duration of 40 minutes and the bases were subjected to 36 cycles. While the base consisting of nickel-plated steel did not demonstrate any change, a slight yellowing could be perceived with the stainless steel base.

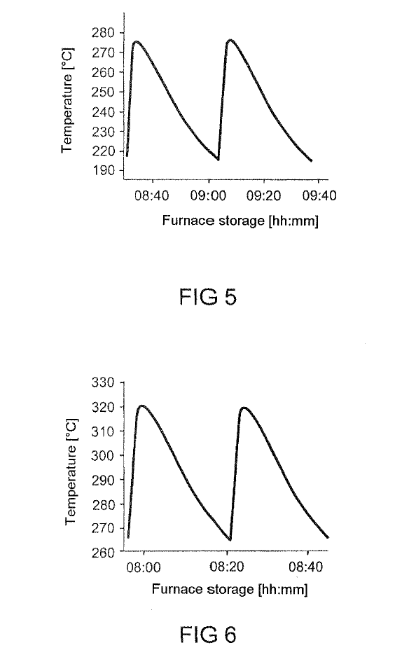

FIG. 5 shows the temperature profile at 280° C., in which a thermal cycle had a duration of 35 minutes and the bases were subjected to 41 cycles. No changes could be perceived with the base consisting of nickel-plated steel, while increased yellowing could be noted on the stainless steel base according to the invention.

FIG. 6 shows the temperature profile at 330° C., in which a thermal cycle had a duration of 25 minutes and the bases were subjected to 57 cycles. While the base consisting of nickel-plated steel did not demonstrate any change, the yellowing with the stainless steel base according to the invention had intensified further.

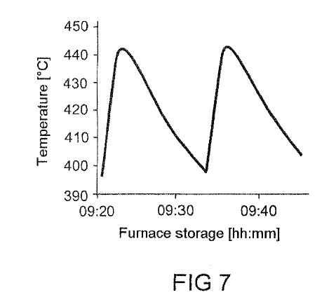

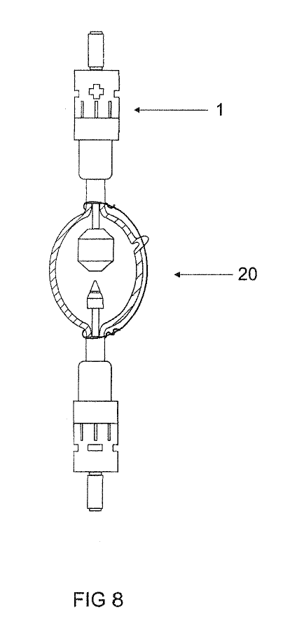

FIG. 7 shows the temperature profile at 440° C., in which a thermal cycle had a duration of 15 minutes and the bases were subjected to 96 cycles. The stainless steel base of the present invention demonstrated yet further yellowing. With the steel base, visible yellowing could be perceived.

This series of tests shows that the base according to the invention consisting of stainless steel material can advantageously be used as a temperature indicator. The slow and easily visible transition region in the tarnishing color of the stainless steel base in which the yellow tarnishing color became ever stronger did not arise with the nickel-plated steel base.

The invention discloses a base for a discharge lamp having a stainless steel material which discolors in the visible region above a predetermined temperature, it being possible to perceive such a discoloration preferably above approximately 230° C. with an increasingly strong yellow tarnishing color.

The present invention is not restricted to a lamp with a base at two ends or to a high-pressure discharge lamp; the invention can also be used in any desired type of discharge lamps with a base at one end.

FIG. 8 shows an XBO high-pressure lamp 20 having such a base 1.

### LIST OF REFERENCE SYMBOLS

1 Base
2 Discharge vessel
3 Base sleeve
4 Fastening ring
5 Sleeve section
8 Hollow cylinder section
10 Power supply line
12 End face
14 Electrode holding rod
20 XBO high-pressure lamp

1. A base (1) for a lamp, preferably a discharge lamp, wherein at least sections of the base (1) have a stainless steel material which discolors in the visible spectral region above a predetermined temperature.

2. The base as claimed in claim 1, a visible discoloration of the stainless steel material beginning at a temperature which is in the range from approximately 230° C. to approximately 280° C., inclusive.

3. The base as claimed in claim 1, a visible discoloration of the stainless steel material beginning above a temperature of approximately 280° C.

4. The base as claimed in claim 1, the base (1) being formed in such a way that, when a discharge vessel (2) of the discharge lamp has been introduced into the base (1), the section consisting of the stainless steel material is provided adjacent to said discharge vessel, preferably such that it is in touching contact with it.

5. The base of a lamp as claimed in claim 1, the base having nickel-plated steel material and a section consisting of stainless steel material.

6. The base of a lamp as claimed in claim 1, at least sections of the base sleeve of the base and at least sections of the fastening ring of the base have the stainless steel material which discolors in the visible region above a predetermined temperature.

7. A lamp having a base as claimed in claim 1.

8. The base as claimed in claim 2, the base (1) being formed in such a way that, when a discharge vessel (2) of the discharge lamp has been introduced into the base (1), the section consisting of the stainless steel material is provided adjacent to said discharge vessel, preferably such that it is in touching contact with it.

9. The base as claimed in claim 3, the base (1) being formed in such a way that, when a discharge vessel (2) of the discharge lamp has been introduced into the base (1), the section consisting of the stainless steel material is provided adjacent to said discharge vessel, preferably such that it is in touching contact with it.

10. The base of a lamp as claimed in claim 2, the base having nickel-plated steel material and a section consisting of stainless steel material.

11. The base of a lamp as claimed in claim 3, the base having nickel-plated steel material and a section consisting of stainless steel material.

12. The base of a lamp as claimed in claim 4, the base having nickel-plated steel material and a section consisting of stainless steel material.

13. The base of a lamp as claimed in claim 2, at least sections of the base sleeve of the base and at least sections of the fastening ring of the base have the stainless steel material which discolors in the visible region above a predetermined temperature.

14. The base of a lamp as claimed in claim 3, at least sections of the base sleeve of the base and at least sections of the fastening ring of the base have the stainless steel material which discolors in the visible region above a predetermined temperature.

15. The base of a lamp as claimed in claim 4, at least sections of the base sleeve of the base and at least sections of the fastening ring of the base have the stainless steel material which discolors in the visible region above a predetermined temperature.

16. The base of a lamp as claimed in claim 5, at least sections of the base sleeve of the base and at least sections of the fastening ring of the base have the stainless steel material which discolors in the visible region above a predetermined temperature.

17. A lamp having a base as claimed in claim 2.

18. A lamp having a base as claimed in claim 3.

19. A lamp having a base as claimed in claim 4.

20. A lamp having a base as claimed in claim 5.
